(19) United States
(12) Patent Application Publication
(10) Pub. No.: US 2015/0206171 A1
(43) Pub. Date: Jul. 23, 2015

(54) Validating Components Of An Advertisement For Consistency With An Objective Of The Advertisement

(71) Applicant: Facebook, Inc., Menlo Park, CA (US)

(72) Inventors: Philip Anastasios Zigoris, San Francisco, CA (US); David Michael Proudfoot, Mountain View, CA (US); Jinghao Yan, Cupertino, CA (US)

(73) Assignee: Facebook, Inc., Menlo Park, CA (US)

(21) Appl. No.: 14/159,996

(22) Filed: Jan. 21, 2014

(51) Int. Cl. G06Q 30/02

(52) U.S. Cl. CPC G06Q 30/0242

(57) ABSTRACT

An online system receives an advertisement request from an advertiser and determines an advertisement objective associated with the advertisement request. Validation rules associated with the advertisement request are retrieved and applied to components of the advertisement request. Application of the validation rules determines whether components of the advertisement request are consistent with the advertisement objective. A result of the application of the validation rules to the advertisement request is presented to the advertiser, providing the advertiser with a measure of the effectiveness of the advertisement request in satisfying the advertisement objective.

### BACKGROUND

This disclosure relates generally to advertising via online systems, and more specifically to evaluating the effectiveness of submitted advertisement requests.

An online system, such as a social networking system, allows its users to connect to and communicate with other online system users. Users may create profiles on an online system that are tied to their identities and include information about the users, such as interests and demographic information. The users may be individuals or entities such as corporations or charities. Because of the increasing popularity of online systems and the increasing amount of user-specific information maintained by online systems, an online system provides an ideal forum for advertisers to increase awareness about products or services by presenting advertisements to online system users.

Presenting advertisements to online system users allows an advertiser to gain public attention for products or services or to persuade online system users to take an action regarding the advertiser's products or services. Many online systems generate revenue by displaying advertisements to their users. Frequently, online systems charge advertisers for each presentation of an advertisement to an online system user (e.g., each “impression” of the advertisement) or interaction with an advertisement by an online system user.

To present advertisements to users of an online system, an advertiser provides the online system with an advertisement request specifying information for creating an advertisement. For example, the advertisement request identifies an advertisement creative for presentation to online system users, targeting criteria identifying online system users eligible to be presented with the advertisement, a bid amount specifying an amount of compensation the online system receives for presenting the advertisement to one or more users, or other information. Additionally, an advertiser may specify a goal, or objective, for presenting the advertisement. Examples of objectives for presenting the advertisement include increasing a number of users expressing a preference for a page maintained by the online system or increasing user interaction with posts made by the page. However, the information provided by the advertiser to create the advertisement may not result in an advertisement suitable for accomplishing the goal associated with presenting the advertisement.

### SUMMARY

An advertiser provides an online system, such as a social networking system, with an advertisement request describing an advertisement for presentation to online system users. The advertisement (“ad”) request specifies various components of the advertisement. For example, the ad request specifies an advertisement creative for presentation to online system users, targeting criteria identifying online system users eligible to be presented with the advertisement, and one or more bid amounts describing compensation the advertiser provides to the online system for presenting the advertisement. Other suitable information about an advertisement may be included in the ad request. Additionally, the ad request specifies an objective for presentation of the advertisement creative to online system users. Example objectives include online system users installing an application associated with an advertisement creative, online system users interacting with the advertisement creative, online system users performing an action with an object associated with the advertisement creative, or other suitable actions by online system users.

The online system includes one or more validation rules associated with an objective, with each validation rule evaluating a component of an advertisement for consistency with the objective. From the ad request, the online system identifies the objective specified by the advertiser and retrieves one or more validation rules associated with the objective. For example, the online system identifies the objective included in the ad request and retrieves validation rules associated with the objective. Alternatively, the online system analyzes components included in the ad request and determines an objective associated with the ad request based on the components included in the ad request. The one or more validation rules associated with the objective are applied to various components of the ad request to determine whether the components are consistent with the objective. For example, a validation rule determines whether the advertisement creative includes an interface element allowing a user to perform a type of interaction associated with the objective when presented with the advertisement creative.

A result describing application of the one or more validation rules associated with an ad request's objective is communicated from the online system to the advertiser providing the ad request. For example, the result is a value indicating whether at least a threshold number of components of the ad request comply with validation rules associated with the objective of the ad request. Alternatively, the result is a score based on a number or percentage of components of the ad request complying the with the applied validation rules; in one embodiment, the score is proportional to the number or percentage of components of the ad request complying with one or more validation rules. As another example, the result identifies one or more components of the ad request that do not comply with an applied validation rule. In some embodiments, the result includes suggestions to the advertiser for modifying components to comply with an applied validation rule. By providing the result to the advertiser, the online system allows the advertiser to modify the ad request to create an advertisement better suited to satisfy the objective associated with the ad request

### BRIEF DESCRIPTION OF THE DRAWINGS

FIG. 1 is a block diagram of a system environment in which online system operates, in accordance with an embodiment.

FIG. 2 is a block diagram of an online system, in accordance with an embodiment

FIG. 3 is a block diagram of an advertisement request, in accordance with an embodiment.

FIG. 4 is a flow chart of a method for validating an advertisement request based on an objective, in accordance with an embodiment.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

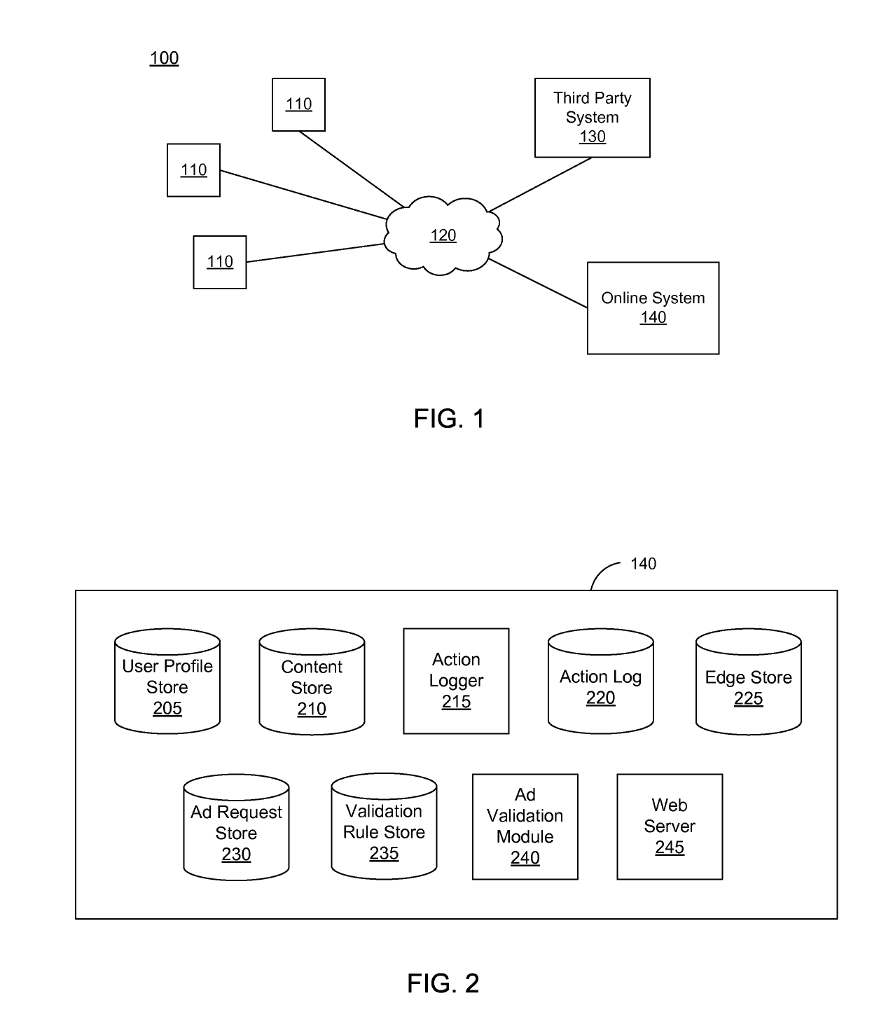

FIG. 1 is a block diagram of a system environment 100 in which an online system 140 operates. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are not online systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. In various embodiments, the online system 140 may be a social networking system. The online system 140 shown in FIG. 2 includes a user profile store 205, a content store 210, an action logger 215, an action log 220, an edge store 225, an advertisement (“ad”) request store 230, a validation rule store 235, an advertisement (“ad”) validation module 240, and a web server 245. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding online system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the online system 1 users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 210, such as status updates, photos tagged by users to be associated with other objects in the online system, events, groups or applications. In some embodiments, objects are received from third-party applications or third-party applications separate from the online system 140. In one embodiment, objects in the content store 210 represent single pieces of content, or content “items.” Hence, online system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of the online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or another user in the online system 140 based on the actions performed by the user. A user's affinity may be computed by the online system 140 over time to approximate a user's interest for an object, interest, or other user in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

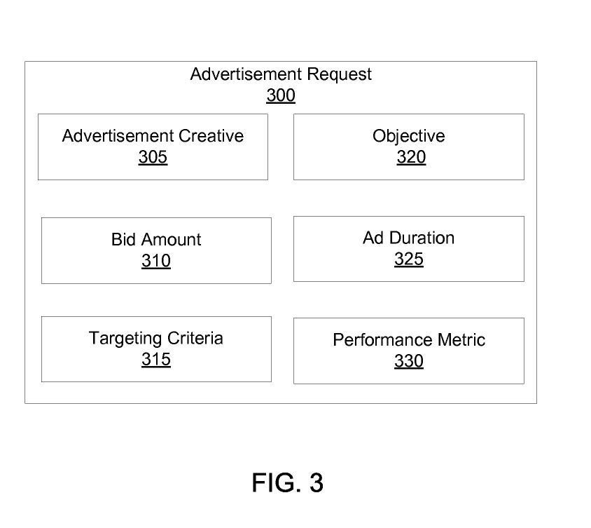

One or more advertisement requests (“ad requests”) are included in the ad request store 230. FIG. 3 shows an example ad request 300 stored in the ad request store 230. An advertisement (“ad”) request includes an advertisement creative 305, which describes content presented to online system users, and a bid amount 310 associated with the advertisement creative. The advertisement creative 305 may be text, image, audio, video, or any other suitable data presented to a user. In various embodiments, the advertisement creative 305 is also associated with a networking address for a landing page or other destination to which a user is directed when the advertisement creative 305 is accessed by a user. The bid amount 310 is associated with an advertisement creative 305 by an advertiser and is used to determine an expected value, such as monetary compensation, provided by an advertiser to the online system 140 if the advertisement creative 305 is presented to a user, if the advertisement creative 305 receives a user interaction, or based on any other suitable condition. For example, the bid amount 310 specifies a monetary amount that the online system 140 receives from the advertiser if the advertisement creative 305 is displayed and the expected value is determined by multiplying the bid amount by a probability of the advertisement being accessed.

Additionally, the advertisement request 300 may include one or more targeting criteria 315 specified by the advertiser. Targeting criteria 315 included in the advertisement request 300 specify one or more characteristics of users eligible to be presented with the advertisement creative 305 included in the advertisement request 300. For example, targeting criteria 315 identifies users having user profile information, edges or actions satisfying at least one of the targeting criteria 315. Hence, targeting criteria 315 allow an advertiser to identify users having specific characteristics, simplifying subsequent distribution of content to different users.

In one embodiment, targeting criteria 315 may specify actions or types of connections between a user and another user or object maintained by the online system 140. Targeting criteria 315 may also specify interactions between a user and objects performed external to the online system 140, such as on a third party system 130. For example, targeting criteria 315 identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria 315 allows advertisers to further refine users eligible to be presented with the advertisement creative 305 included in an advertisement request 300. As another example, targeting criteria 315 identifies users having a connection to another user or object or having a particular type of connection to another user or object.

Additionally, the advertisement request 300 may also include an advertisement objective 320 specifying a goal of the advertiser for presentation of the advertisement creative 305 in the advertisement request 300 to online system users 140. For example, the objective 320 identifies a type of interaction with the advertisement creative 305 or with an object associated with the advertisement creative 305 by online system users presented with the advertisement creative 305. Examples of objectives include: online system users accessing a presented advertisement creative 305 (e.g., clicking or otherwise accessing the advertisement creative 305), online system users installing an application associated with the advertisement request 300, online system users expressing a preference for a page associated with the advertisement request (i.e., “liking” the page), online system users viewing a page associated with the advertisement request, or any other suitable action by online system users. In one embodiment, the advertisement objective 320 is selected from a set of advertisement objectives 320 maintained by the online system 140.

Additionally, the advertisement request 300 may include an advertisement duration 325 specifying a time interval during which the advertisement creative 305 is presented to online system users. The advertisement duration 325 may be specified by an advertiser associated with the advertisement request 300 or may be determined by the online system 140. In some embodiments, a performance metric 330 is included in the advertisement request 300 specifying a metric or value for evaluating a benefit to the advertiser from presenting the advertisement creative 305. For example, the performance metric 330 specifies a number of interactions with a presented advertisement creative 305 during a time interval or specifies a number of interactions with an object associated with the advertisement request 330 within the time interval. Additional information may be included in the advertisement request 300 in various embodiments. For example, the advertisement request 300 includes a budget that specifies a total amount of compensation an advertiser provides the online system 140 for presenting the advertisement creative 305.

The validation rule store 235 includes one or more validation rules associated with various advertisement objectives. A validation rule associated with an advertisement objective provides a measure of whether one or more components of an advertisement request advance an advertisement objective associated with the advertisement request. Different validation rules may be applied to different components of an advertisement request to determine whether various components of the advertisement request advance the advertisement objective associated with the advertisement request. For example, if an advertisement objective is to receive online system users expressing a preference for a page associated with an advertisement request, a validation rule associated with that objective determines whether targeting criteria of the advertisement request allow presentation of an advertisement creative to at least a threshold number of online system users.

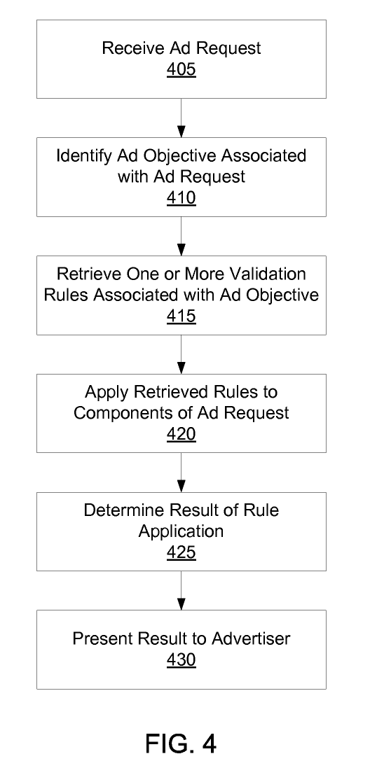

When the online system 140 receives an advertisement request, the advertisement validation module 240 identifies an advertisement objective associated with the advertisement request and retrieves one or more validation rules associated with the identified advertisement objective from the validation rule store 235. The advertisement validation module 240 applies the retrieved validation rules to the received advertisement request to assess whether various components of the advertisement request comply with its associated advertisement objective. A result describing application of the one or more validation rules to the advertisement request is communicated from the online system 140 to an advertiser associated with the received advertisement request. Based on the result, the advertiser may modify one or more components of the advertisement request to increase the likelihood of the advertisement request satisfying its associated advertisement objective. Application of validation rules to a received advertisement request is further described below in conjunction with FIG. 4.

The web server 245 links the online system 140 via the network 120 to the one or more client devices 110, as well as to the one or more third party systems 130. The web server 245 serves web pages, as well as other content, such as JAVA®, FLASH®, XML and so forth. The web server 245 may receive and route messages between the online system 140 and the client device 110, for example, instant messages, queued messages (e.g., email), text messages, short message service (SMS) messages, or messages sent using any other suitable messaging technique. A user may send a request to the web server 245 to upload information (e.g., images or videos) that are stored in the content store 210. Additionally, the web server 245 may provide application programming interface (API) functionality to send data directly to native client device operating systems, such as IOS®, ANDROID™, WEBOS® or BlackberryOS.

### Advertisement Request Validation Based on an Objective

FIG. 4 is a flow chart of one embodiment of a method for validating an advertisement request against an advertisement objective. In various embodiments, the steps described in conjunction with FIG. 4 may be performed in different orders. Additionally, in some embodiments, the method may include different and/or additional steps than those described in conjunction with FIG. 4.

The online system 140 receives 405 an advertisement (“ad”) request from an advertiser. Alternatively, the online system 140 retrieves a stored advertisement request previously received from an advertiser. The advertisement request describes an advertisement for presentation to online system users by the online system 140. As described above in conjunction with FIGS. 2 and 3, the advertisement request includes various components, such as an advertisement creative, one or more bid amounts, targeting criteria, and/or additional information.

An advertisement objective associated with the advertisement request is identified 410 by the online system 140. In one embodiment, the advertisement request includes an advertisement objective specifying a goal of the advertiser for presenting an advertisement creative in the advertisement request to one or more online system users, so the online system 150 identifies 410 the advertisement objective specified by the advertisement request. Alternatively, the online system 140 may identify 410 the advertisement objective based on other components of the advertisement request, as further described below.

Based on the identified advertisement objective, the online system 140 retrieves 415 one or more validation rules. For example, one or more validation rules stored by the online system 140 and associated with the identified advertisement objective are retrieved 415. The online system 140 applies 420 the retrieved one or more validation rules to components of the advertisement request. As described above in conjunction with FIG. 2, applying 420 a validation rule to a component of the advertisement request determines whether the component is consistent with the advertisement objective associated with the advertisement request. A component that is consistent with the advertisement objective is a component having a value having at least a threshold likelihood of satisfying the advertisement objective. In one embodiment, validation rules associated with an advertisement objective are determined by the online system based on values of components of advertisement requests having the advertisement objective and including advertisement creatives previously presented to users of the online system 140. Alternatively, validation rules associated with an advertisement objective are provided to the online system 140 by an advertiser and stored by the online system 140 for application to advertisement requests subsequently received from the advertiser.

The online system 140 determines 425 a result from application of the one or more retrieved validation rules to components of the received advertisement request and presents 430 the result to an advertiser associated with the retrieved advertisement request. In one embodiment, the result is a value indicating whether at least a threshold number or percentage of components of the received advertisement request are consistent with the identified advertisement objective. For example, the result is a Boolean value having a value if at least a threshold percentage of components of the received advertisement request are consistent with the identified advertisement objective and a different value if less than a threshold percentage of components of the received advertisement request are consistent with the identified advertisement objective. Alternatively, the result is a score that is proportional to a number or percentage of components of the received advertisement request that are consistent with the identified advertisement objective. Hence, advertisement requests with greater scores have a greater number or percentage of components that are consistent with the identified advertisement objective. In another embodiment, the result identifies one or more components of the received advertisement request that are not consistent with the advertisement objective. Additionally, the result may include modifications to components of the advertisement request that are not consistent with the advertisement objective so the modified components are consistent with the advertisement objective. In some embodiments, the online system 140 determines suggestions for modifications to components of the advertisement request based on values of components of advertisements requests with previously-presented advertisement creatives and associated with an advertisement objective matching the advertisement objective of the advertisement request. In some embodiments, the received advertisement request does not include a component specifying an advertisement objective, so the online system 140 may determine an advertisement objective for the received advertisement request based on components of the received advertisement request. For example, the online system 140 retrieves various groups of validation rules, with each group associated with an advertisement objective. Validation rules from each group are applied to one or more components of the received advertisement request, with a score generated for each group of validation rules based on the number or percentage of components of the received advertisement request that are consistent with an advertisement objective associated with a group of validation rules. Based on the scores associated with the groups of validation rules, the online system 140 determines an advertisement objective associated with the received advertisement request. For example, an advertisement objective associated with a group of validation rules associated with a maximum score is identified 410 as the advertisement objective associated with the received advertisement request. The received advertisement request is then evaluated against the identified advertisement objective as described above.

### SUMMARY

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A method comprising:
receiving an advertisement request including a plurality of components and associated with an advertisement objective selected from a plurality of predefined objectives;
identifying the advertisement objective associated with the received advertisement request;
retrieving one or more validation rules associated with the identified advertisement objective;
applying the retrieved one or more validation rules to components of the advertisement request;
determining a result of the application of the retrieved one or more validation rules to the components of the advertisement request, the result providing a measure of consistency of components of the advertisement with the advertisement objective; and
providing the result to an advertiser associated with the advertisement request.

2. The method of claim 1, wherein one or more components included in the advertisement request are selected from a group consisting of: an advertisement creative comprising content for presentation to a user, one or more targeting criteria specifying characteristics of users eligible to be presented with the advertisement creative, a bid amount specifying an amount of compensation provided by the advertiser to an online system for presenting the advertisement creative, and any combination thereof.

3. The method of claim 1, wherein a component included in the advertisement request includes the advertisement objective.

4. The method of claim 1, wherein identifying the advertisement objective associated with the received advertisement request comprises:
identifying a component of the received advertisement request specifying the advertisement objective.

5. The method of claim 1, wherein identifying the advertisement objective associated with the received advertisement request comprises:
selecting a set of validation rules, the set including a plurality of groups of validation rules, each group of validation rules associated with an advertisement objective;
generating a score associated with each group of validation rules by applying one or more validation rules from each group to one or more components of the received advertisement request; and
selecting the advertisement objective based at least in part on the scores associated with each group of validation rules.

6. The method of claim 1, wherein selecting the advertisement objective based at least in part on the scores associated with each group of validation rules comprises:
selecting an advertisement objective associated with a group of validation rules associated with a maximum score.

7. The method of claim 1, wherein the result of the application of the retrieved one or more validation rules to the components of the advertisement request comprises:
a value indicating whether at least a threshold number of components of the advertisement request are consistent with the advertisement objective.

8. The method of claim 1, wherein the result of the application of the retrieved one or more validation rules to the components of the advertisement request comprises:
a value indicating whether at least a threshold percentage of components of the advertisement request are consistent with the advertisement objective.

9. The method of claim 1, wherein the result of the application of the retrieved one or more validation rules to the components of the advertisement request comprises:
a score proportional to a number of components of the advertisement request that are consistent with the advertisement objective.

10. The method of claim 1, wherein the result of the application of the retrieved one or more validation rules to the components of the advertisement request comprises:
a score proportional to a percentage of components of the advertisement request that are consistent with the advertisement objective.

11. The method of claim 1, wherein the result of the application of the retrieved one or more validation rules to the components of the advertisement request comprises:
an indication of one or more components of the advertisement request that are not consistent with the advertisement objective.

12. The method of claim 1, wherein the result of the application of the retrieved one or more validation rules to the components of the advertisement request includes one or more modifications to one or more components of the advertisement request that are not consistent with the advertisement objective.

13. A computer system comprising a processor and storage device configured to perform the following:
receive an advertisement request including a plurality of components and associated with an advertisement objective selected from a plurality of predefined objectives;
identify the advertisement objective associated with the received advertisement request;
retrieve one or more validation rules associated with the identified advertisement objective;
apply the retrieved one or more validation rules to components of the advertisement request;
determine a result of the application of the retrieved one or more validation rules to the components of the advertisement request, the result providing a measure of consistency of components of the advertisement with the advertisement objective; and
provide the result to an advertiser associated with the advertisement request.

14. The system of claim 13, wherein one or more components included in the advertisement request are selected from a group consisting of: an advertisement creative comprising content for presentation to a user, one or more targeting criteria specifying characteristics of users eligible to be presented with the advertisement creative, a bid amount specifying an amount of compensation provided by the advertiser to an online system for presenting the advertisement creative, and any combination thereof.

15. The system of claim 13, wherein a component included in the advertisement request includes the advertisement objective.

16. The system of claim 13, wherein identify the advertisement objective associated with the received advertisement request comprises:
identify a component of the received advertisement request specifying the advertisement objective.

17. The system of claim 13, wherein identify the advertisement objective associated with the received advertisement request comprises:
select a set of validation rules, the set including a plurality of groups of validation rules, each group of validation rules associated with an advertisement objective;
generate a score associated with each group of validation rules by applying one or more validation rules from each group to one or more components of the received advertisement request; and
select the advertisement objective based at least in part on the scores associated with each group of validation rules.

18. The system of claim 13, wherein select the advertisement objective based at least in part on the scores associated with each group of validation rules comprises:
select an advertisement objective associated with a group of validation rules associated with a maximum score.

19. The system of claim 13, wherein the result of the application of the retrieved one or more validation rules to the components of the advertisement request comprises:
a value indicating whether at least a threshold number of components of the advertisement request are consistent with the advertisement objective.

20. The system of claim 13, wherein the result of the application of the retrieved one or more validation rules to the components of the advertisement request comprises:
a value indicating whether at least a threshold percentage of components of the advertisement request are consistent with the advertisement objective.

21. The system of claim 13, wherein the result of the application of the retrieved one or more validation rules to the components of the advertisement request comprises:
a score proportional to a number of components of the advertisement request that are consistent with the advertisement objective.

22. The system of claim 13, wherein the result of the application of the retrieved one or more validation rules to the components of the advertisement request comprises:
a score proportional to a percentage of components of the advertisement request that are consistent with the advertisement objective.

23. The system of claim 13, wherein the result of the application of the retrieved one or more validation rules to the components of the advertisement request comprises:
an indication of one or more components of the advertisement request that are not consistent with the advertisement objective.

24. The method of claim 13, wherein the result of the application of the retrieved one or more validation rules to the components of the advertisement request includes one or more modifications to one or more components of the advertisement request that are not consistent with the advertisement objective.

25. A computer program product comprising a computer readable storage medium having instructions encoded thereon that, when executed by a processor, cause the processor to:
receive an advertisement request including a plurality of components and associated with an advertisement objective;
identify the advertisement objective associated with the received advertisement request;
retrieve one or more validation rules associated with the identified advertisement objective;
apply the retrieved one or more validation rules to components of the advertisement request;
determine a result of the application of the retrieved one or more validation rules to the components of the advertisement request, the result providing a measure of consistency of components of the advertisement with the advertisement objective; and
provide the result to an advertiser associated with the advertisement request.
